(19) United States
(12) Patent Application Publication
(10) Pub. No.: US 2015/0199631 A1
(43) Pub. Date: Jul. 16, 2015

(54) PERFORMANCE OF TASKS WITHIN ORGANIZATIONS

(71) Applicants: Anupriya Ankolekar, Palo Alto, CA (US); Sitaram Asur, Palo Alto, CA (US); Filippo Balestrieri, Palo Alto, CA (US); Bernardo Huberman, Palo Alto, CA (US)

(72) Inventors: Anupriya Ankolekar, Palo Alto, CA (US); Sitaram Asur, Palo Alto, CA (US); Filippo Balestrieri, Palo Alto, CA (US); Bernardo Huberman, Palo Alto, CA (US)

(73) Assignee: HEWLETT-PACKARD DEVELOPMENT COMPANY, L.P., Houston, TX (US)

(21) Appl. No.: 14/154,563

(22) Filed: Jan. 14, 2014

(51) Int. Cl. G06Q 10/06

(52) U.S. Cl. CPC G06Q 10/06311

(57) ABSTRACT

Examples relate to performance of tasks within organizations. In example implementations, a computing device receives a user profile of a plurality of users in an organization. The device may receive a task from a first user in the organization including an action to be performed by one user on behalf of another. In response, the device may receive a plurality of bids from other users in the organization, where each bid specifies a number of credits to be exchanged between the first user and a second user for performance of the task. The device may receive a selection of a particular bid from the first user. Upon performance of the task, the device may exchange the specified number of credits between the first user and the second user.

### BACKGROUND

In order to function effectively, large organizations adopt hierarchies and processes. Each member of such an organization may be assigned to a specific role, with specific task requirements, in a given division. As the organization grows in size, its members may lose awareness of the needs of people in other divisions, and even low-cost, high-return collaboration opportunities may be lost. As a result, the organization may not invest its resources most efficiently.

### BRIEF DESCRIPTION OF THE DRAWINGS

The following detailed description references the drawings, wherein:

FIG. 1 is a block diagram of an example computing device for performance of tasks within an organization;

FIG. 2 is a block diagram of an example computing device for performance of tasks within an organization using exchanges of tasks and bids between users;

FIG. 3 is a flowchart of an example method for performance of tasks within an organization;

FIG. 4A is a flowchart of an example method for creating a task by a user within an organization;

FIG. 4B is a flowchart of an example method for creating and submitting a bid, by a user within the organization, for the created task of FIG. 4A;

FIG. 5A is a diagram of an example user interface in which a user may create a task;

FIG. 5B is a diagram of an example user interface in which a user may create a bid for a task;

FIG. 5C is a diagram of an example user interface in which a user may select a bid;

FIG. 5D is a diagram of an example user interface in which a user's profile is displayed.

### DETAILED DESCRIPTION

When assigning responsibilities to its members, an organization may need to balance long-term discipline with short-term efficiency. Long-term discipline is the necessary focus on the primary responsibilities that each member is expected to have in his or her role within the organization. Short-term efficiency refers to the most effective investment of a given member's expertise. Unyielding focus on long-term discipline may prevent an efficient use of human capital. On the other hand, over-emphasis on short-term efficiency may threaten the structural nature of the organization.

Examples disclosed herein address these problems by facilitating a task marketplace for creating and performing tasks between users within an organization. In such marketplaces, credits may be exchanged for the performance of tasks by one user on behalf of another. In examples herein, a computing device may receive user profiles of a plurality of users in the organization including each user's limit of credits for use in compensating other users for performing tasks. The device may then receive a task from a first user in the organization including an action to be performed by one user on behalf of another user. The device may receive a plurality of bids from other users in the organization, where each bid specifies a number of credits to be exchanged between the first user and a second user for performance of the task and where the number of credits in each bid is restricted by the limit of credits in the user profile for the first user, for the second user, or for both users. The device may then receive a selection of a particular bid from the first user. For performance of the task, the device may exchange the specified number of credits between the first user and the second user.

In this manner, examples disclosed herein utilize the exchange of tasks and bids between members of an organization to facilitate a market-like environment for tasks, thereby enabling productive intra-organization collaboration without disrupting the primary activities of the organization. Examples herein respect the primary responsibilities of members of the organization by limiting the number of credits each user may have for compensating other users for performing tasks. In particular, setting a credit limit allows market forces to determine the appropriate types of tasks that may be created. For example, if a task garners no bids from other users, it may mean that it is more appropriate to obtain the services in other ways, such as engaging external help or other members in the organization in a more formal collaboration. Furthermore, limiting each user's credits also limits the types of members that volunteer for tasks because different people have different opportunity costs for their time.

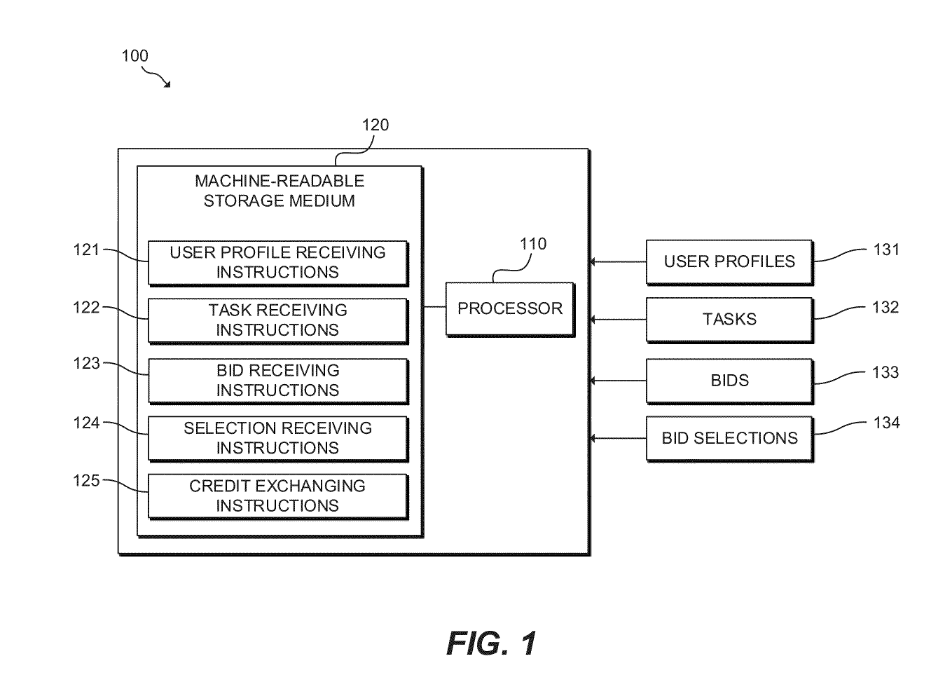

Referring now to the figures, FIG. 1 is a block diagram of an example computing device 100 for performance of tasks within an organization. Computing device 100 may be, for example, a local area network (LAN) server, a web server, a cloud-hosted server, a personal computing device (e.g., a notebook computer, desktop computer, or mobile device), or any other electronic device suitable for executing the functionality described below. In the implementation of FIG. 1, computing device 100 includes a processor 110 and a non-transitory machine-readable storage medium 120.

Processor 110 may be one or more central processing units (CPUs), semiconductor-based microprocessors, and/or other hardware devices suitable for retrieval and execution of instructions stored in machine-readable storage medium 120. Processor 110 may fetch, decode, and execute instructions 121, 122, 123, 124, 125 to control the process for performance of tasks within an organization. As an alternative or in addition to retrieving and executing instructions, processor 110 may include one or more electronic circuits that include electronic components for performing the functionality of one or more of instructions 121, 122, 123, 124, 125.

Machine-readable storage medium 120 may be any electronic, magnetic, optical, or other physical storage device that contains or stores executable instructions. Thus, machine-readable storage medium 120 may be, for example, Random Access Memory (RAM), an Electrically Erasable Programmable Read-Only Memory (EEPROM), a storage device, an optical disc, and the like. Storage medium 120 may be a non-transitory storage medium, where the term “non-transitory” does not encompass transitory propagating signals. As described in detail below, machine-readable storage medium 120 may be encoded with a series of executable instructions 121, 122, 123, 124, 125 for receiving user profiles of a plurality of users in the organization, receiving a task, receiving a plurality of bids, receiving a selection of a particular bid, and exchanging credits.

User profile receiving instructions 121 may receive user profiles 131 of a plurality of users in the organization. As used herein, the term “user” may refer to a member of an organization. In an example, a user may be a member of the organization who agrees to participate in the task marketplace. Users may be members of different subgroups within the organization. A first user and second user, for example, may be employees in different divisions of an enterprise who otherwise may not participate in cross-divisional collaboration.

An organization may be, for example, a business enterprise that adopts a multi-layered employee hierarchy, a large community group including members in various subgroups, or a government entity including numerous committees and divisions. Thus, the term “organization” should be understood to encompass any grouping of people with a member structure. As one specific example, the organization may be a large, international company with an intricate management structure and numerous employees assigned into divisions based on their skills.

User profiles 131 received by receiving instructions 121 may include any information relating to users within the organization that is used in the process of creating and performing tasks within the organization. User profiles 131 may include information regarding members of an organization that is accessed from a local database, a cloud-hosted database, a data center, or any other source of information. In another example, the data for user profiles 131 is provided directly by each user when he or she registers to participate in the task marketplace.

In some implementations, each user profile includes the user's limit of credits for use in compensating other users for performing tasks, where the term “credit” refers to points, currency, or any other variable representation of value. For example, such credits may be managed by the organization as an internal points system used to track employee performance and to incentivize collaborations. The limit stored in user profiles 131 may serve as a budget for each user when exchanging credits for performance of tasks. In particular, the limit may be used to ensure that a user may not provide more than a given number of credits to another user in exchange for successful performance of a task. Furthermore, user profiles 131 may place a limit on the total number of credits a user may possess at any time, such that computing device 100 prevents the user from bidding for tasks when he or she has reached the limit of credits.

User profiles 131 may also include a limit on the number of credits a user may earn over a period of time. For example, such a limit may prevent the user from earning more than a preset number of credits within a week, a month, or a year. In addition or as an alternative, user profiles 131 may include a limit on the number of tasks the user may perform over a period of time. For example, such a limit may prevent the user from performing more than a preset number of tasks within a week, a month, or a year. In such instances, user profile receiving instructions 121 may prevent the particular user from further participating in the task marketplace.

In some implementations, user profiles 131 may specify credit limits or task limits set by another user or other source. For example, the number of credits an employee of a business may spend to compensate others for completing tasks may be limited by the employee's supervisor as an attempt to accomplish a balance of two factors. First, the supervisor may want the employee to give certain tasks to other users for greater efficiency. On the other hand, the supervisor may want to limit the total amount of time and attention the employee spends on the task marketplace in order to direct focus to the employee's main work responsibilities.

In some examples, different users within the organization may have different credit limits or task limits specified in their respective user profiles 131. In some implementations, each user's credit or task limit may be determined by the user's particular role within the organization. In an enterprise setting, certain employees may need to create and/or perform a large number of tasks. For example, an employee in a technology support position, whose main responsibility is to support a number of other employees' technology issues, may be most effective when allowed to freely participate in the task marketplace. On the other hand, significant participation in the task marketplace may inhibit the productivity of an employee with specific and defined roles. Flexibility in assigning different credit or task limits for different users in an organization may allow customizing incentives to encourage maximum effectiveness.

Furthermore, in some implementations, multiple types of credits may be exchanged for performance of tasks within an organization. A task marketplace that uses multiple types of credits may allow the organization to recognize different priority rights that pertain to different groups of members in the organization. In particular, some types of credits may only be used by certain users in the organization. For example, a high-level officer may be allowed to exchange “elite points” for tasks of the highest priority to the executive committee of a company.

Alternatively or in addition, one type of credits, for which users do not have an earnings limit, may only be exchanged for certain kinds of tasks, such as simple errand-like activities. Another type of credits may be limited in the amount that may be earned by users but may be exchangeable for performance of work-related tasks, such as ones for a major project. As an example, in some instances, a user may prefer to earn credits that are not limited, whereas in other instances, a user may prefer to earn credits that may be used as a performance metric by the organization. The use of multiple types of credits may allow the organization to encourage performance of tasks in line with the organization's goals and priorities.

In addition to information describing credit limits, user profiles 131 may store additional data relating to each of the users. For example, user profiles 131 may include each user's role within the organization (e.g., engineering, marketing, legal, etc.), each user's geographical location, each user's skills (e.g., graphical design, 3D modeling, contract negotiation, etc.), the number of tasks performed by each user, each user's task performance rate (e.g. percentage of tasks performed successfully), and/or reviews for the tasks performed by each user. In some examples, user profiles 131 include the user's geographical location and skill certifications. Such information may permit another user accessing user profiles 131 to determine the user's ability to perform a particular task.

Task receiving instructions 122 may receive a task 132 from a first user in the organization, where the task includes an action to be performed by one user on behalf of another user. In some implementations, a task may be a request by the first user for the performance of a certain action by a second user or users. For example, the first user may desire to have another member of the organization help with an IT issue, design a presentation, or perform some other task in which the first user lacks the expertise or time, or would simply prefer to have someone else perform the task. In other implementations, a task may be an offer by the first user to perform a certain action for other users. For example, the first user may offer to help other members of the organization with an IT issue, design a presentation, or perform some other task.

To facilitate the interaction between users in the organization, task 132 may store any information that assists in identifying the task. In one example, task 132 includes a description of the task, a time of expiration, and/or a categorization of the task. Task 132 may be provided to task receiving instructions 122 by a number of means. For example, task 132 may be provided by a user using a user interface on a personal computing device, such as a personal computer, tablet, or mobile device. In other examples, task 132 may be accessed from a local database, cloud-hosted database, a data center, or another local or remote storage means.

As mentioned above, task 132 may include an action to be performed by one user on behalf of another user. Performance of the task may be completed when a user has successfully completed all conditions for performing the task that were specified when the task was created. In an example, a first user may indicate, upon a second user's performance, whether the second user has successfully satisfied all conditions of the task. A positive indication may close the task and initiate a credit exchange between the first user and the second user, as described further below in connection with credit exchanging instructions 125. In another example, a condition for the task may include a time of expiration for performance of the task.

Furthermore, task 132 may in some implementations include a credit limit specified by the first user. In examples where the task is a request for other users to perform an action on the first user's behalf, the credit limit may be the maximum number of credits the first user is willing to pay for performance of the task, such that bids by other users are constrained by this credit limit. Alternatively, in implementations where the task is an offer for the first user to perform an action on another user's behalf, the credit limit may be the minimum number of credits for which the first user is willing to perform the offered action. In some examples, a credit limit may be modified by the first user at a time after task creation. If a task receives no bids, for example, the first user may exercise the discretion to increase or decrease the credit limit for the task accordingly, hoping to attract more bids.

Task 132 may in some implementations be limited by a predetermined maximum credit amount, which may be the highest number of credits a user may exchange for any task. In some implementations, the predetermined maximum credit amount may be set by another user or other source. For example, the number of credits a user may provide to another user for performing any task may be limited by a supervisor of the user in the organization as an attempt to control the types of tasks that are created and performed.

In some implementations, the predetermined maximum credit amount for tasks may be different for different users or different categories of tasks. Customizing the maximum credit amount for tasks for different users may allow an organization to boost efficiency while also recognizing the hierarchy and structure of the organization. For example, a manager in an organization who regularly assigns various projects to other employees may be assigned a larger credit amount to provide greater flexibility in creating tasks than a lower-level employee who may only desire to request or offer simple errands. In one implementation, a project manager in an enterprise may use the process implemented by computing device 100 to distribute a number of projects to a group of employees under the manager's supervision. In such an example, the project manager may need a higher predetermined maximum credit amount for tasks than other employees.

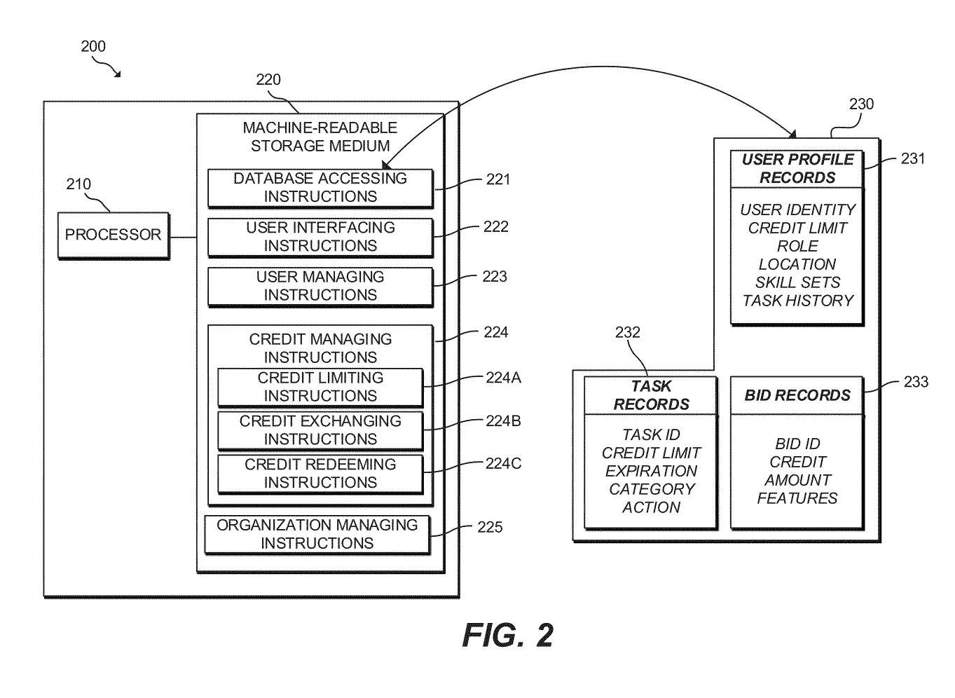

Task 132 may also include other features in addition to the description of the task and credit limit information. For example, task 132 may include a categorization of the task, which may be any identifying characteristic that may allow the grouping of multiple tasks. Categorization of tasks may allow users to easily find tasks within a listing or database. For example, a user may use a search function of a user interface to identify tasks suitable for the user's particular skills, geographic location, and other characteristics. Furthermore, task 132 may include additional restrictions set by the first user. For example, the first user may only accept bids from other users located in a certain geography or with a sufficiently high performance rating as measured by prior task performance. Detailed examples of additional restrictions are described below in relation to FIG. 2.

In some implementations, computing device 100 provides each submitted task 132 to other users in the organization, such that the other users in the organization may view the tasks and create bids. Computing device 100 may provide task 132 to other users using any number of means. In one example, computing device 100 may add task 132 to a database or listing of all created tasks within an organization. Users may then access the database or listing of created tasks with a user interface. In another example, computing device 100 may notify all users within an organization whenever a new task is created.

After receipt of a task 132 from a first user, bid receiving instructions 123 may receive a plurality of bids 133 corresponding to the task from other users in the organization. In examples where task 132 is a request by the first user for another user to perform the action in task 132 on his or her behalf, bid 133 may be an offer from a second user to perform the action. Alternatively, in examples where task 132 is an offer by the first user to perform the action for another user, bid 133 may be a request from a second user for the first user to perform the action in task 132.

Each bid 133 may include a specified number of credits to be exchanged between the first user and a second user for performing task 132. In some implementations, the specified number of credits may be zero, indicating the second user is willing to perform task 132 for free. In instances where task 132 is an offer, the specified number of credits for a bid 133 may be zero when the first user did not set a credit limit for task 132 (i.e. the first user offered to perform task 132 for free).

In some implementations where the first user set a credit limit for task 132 when creating task 132, a second user may be restricted by the credit limit when specifying the number of credits for bid 133. In an example, a second user looking to perform task 132 may not create a bid 133 with a credit amount greater than the limit set by the first user. In other examples, where task 132 is an offer, a second user may not create a bid 133 with a credit amount less than the limit set by the first user, which is the minimum number of credits for which the first user is willing to perform task 132.

Each bid 133 may include other features included by the second user to encourage the first user to select the particular second user. These features may be any information that helps the first user make the decision whether or not to select bid 133. These features, for example, may include the second user's experience, availability, and any other information the second user provides to distinguish bid 133. In some examples, each bid 133 may include information from the second user's user profile.

In some implementations, computing device 100 may then provide each bid 133 for task 132 to the first user who created the task. Computing device 100 may provide the bids 133 to the first user using any number of means. In one example, computing device 100 may add bid 133 to a listing of all created bids associated with task 132. The first user may then access the listing of bids 133 associated with task 132 and view the bids with a user interface in real time or at the end of the time of expiration for task 132. In another example, computing device 100 may notify the first user whenever a second user creates a new bid 133.

After bids 133 have been provided to the first user, selection receiving instructions 124 may receive a bid selection 134 from the first user. Bid selection 134 may indicate which second user the first user has chosen from among the plurality of bids 133. In implementations where task 132 is a request, bid selection 134 may identify the second user that the first user has selected to perform the action in task 132. On the other hand where task 132 is an offer, bid selection 134 may identify the second user for whom the first user will perform the action in task 132.

In some examples, bid selection 134 may include other information in addition to the selection of the particular bid by the first user. For example, bid selection 134 may include additional details regarding task 132, such as a specific time for performance and/or a preferred method for performing task 132. In examples where task 132 includes a time of expiration for bidding for the task, selection receiving instructions 124 may receive bid selection 134 at the time of expiration. In other examples, selection receiving instructions 124 may receive bid selection 134 at any time, regardless of the time of expiration.

Upon successful performance of task 132, credit exchanging instructions 125 may exchange the number of credits specified in the selected bid 133 between the first user and the second user. For example, credit exchanging instructions 125 may deduct the number of credits from one user's user profile and add the same number of credits to the other user's user profile. The exchange of credits between users may be managed and tracked in a number of ways. As one example, computing device 100 may cooperate with an inter-organizational database to store and retrieve credit information for users within the organization.

FIG. 2 is a block diagram of an example computing device 200 for performance of tasks within an organization using exchanges of tasks and bids between users. Computing device 200 may be, for example, a local area network (LAN) server, a web server, a cloud-hosted server, a personal computing device (e.g., a notebook computer, desktop computer, or mobile device), or any other electronic device suitable for executing the functionality described below. In the implementations of FIG. 2, computing device 200 includes a processor 210 and a non-transitory machine-readable storage medium 220, and access to a database 230.

As with processor 110 of FIG. 1, processor 210 may be a central processing unit (CPU), a semiconductor-based microprocessor, or any other hardware device suitable for retrieval and execution of instructions stored in machine-readable storage medium 220. As with machine-readable storage medium 120 of FIG. 1, machine-readable storage medium 220 may be any electronic, magnetic, optical, or other physical storage device that contains or stores executable instructions. Machine-readable storage medium 220 may be encoded with instructions 221-225, executable by processor 210.

Database accessing instructions 221 may access a plurality of items from a database or other information repository. In the implementation of FIG. 2, database accessing instructions 221 may access the information from a number of records 231, 232, 233 in database 230, which may be a local database, a cloud-hosted database, a database maintained in a data center, and/or any other type of database. In particular, each user profile in user profile records 231 may correspond to the user profile of a user. Records 232 and 233 may contain data for each task and bid, respectively.

Database accessing instructions 221 may retrieve information from database 230 and provide retrieved information to computing device 200. In addition or as an alternative, database accessing instructions 221 may provide information from computing device 200 to database 230 for storage. For example, database accessing instructions 221 may retrieve tasks from database 230 to enable users to access the available tasks. In another example, database accessing instructions 221 may store a newly created task in database 230 in order to provide subsequent access to users.

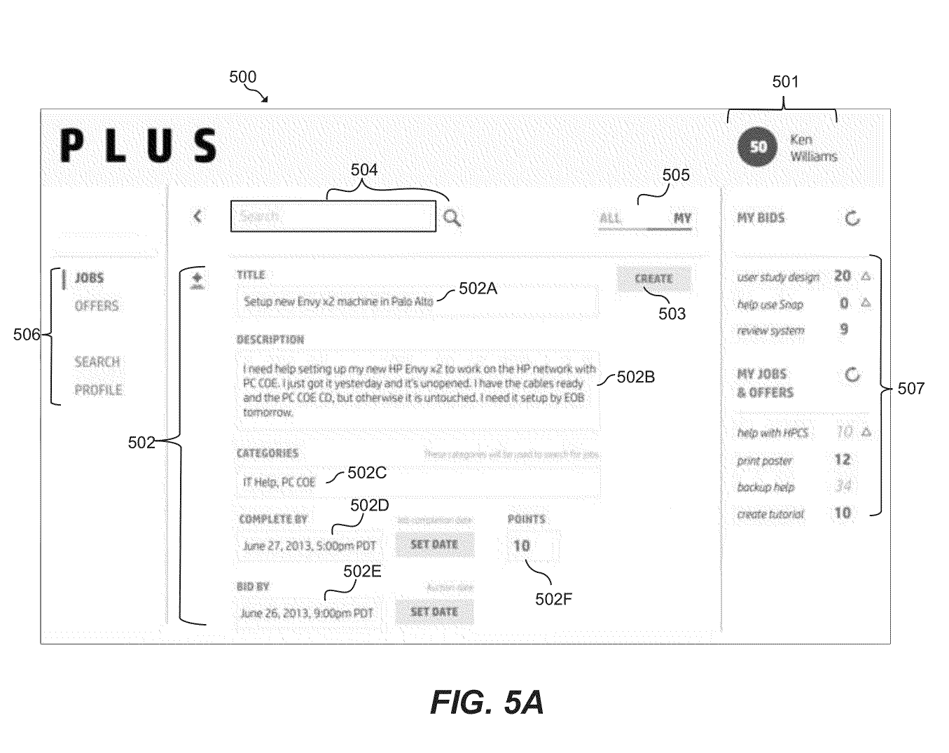

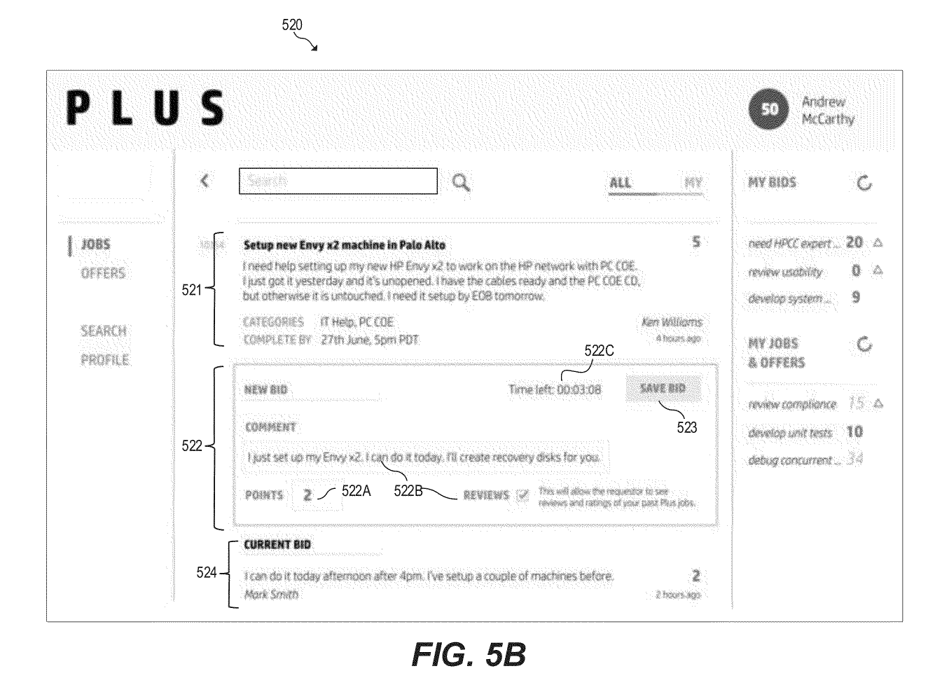

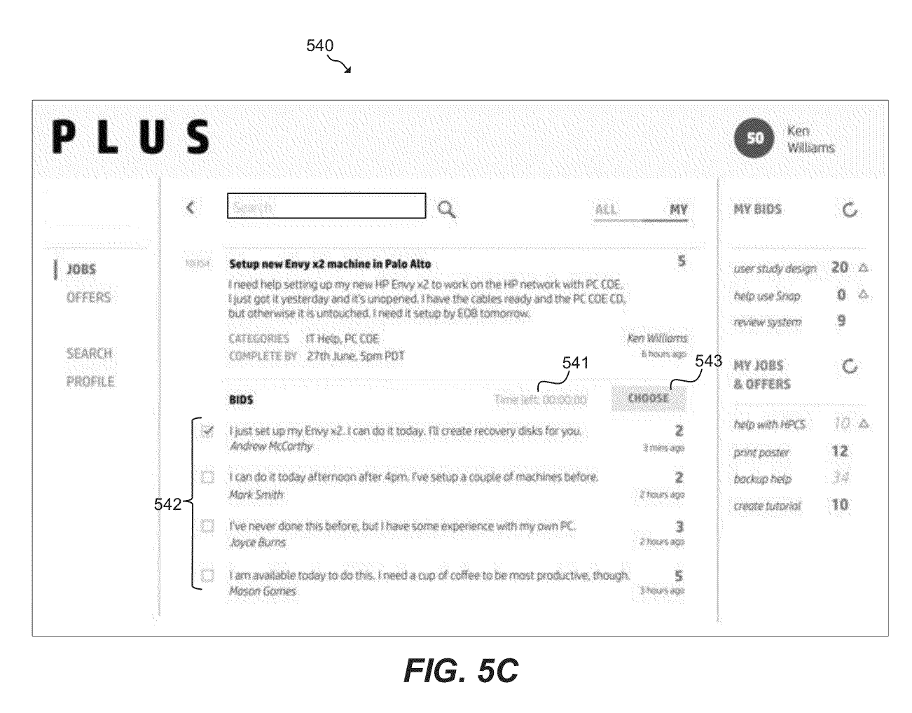

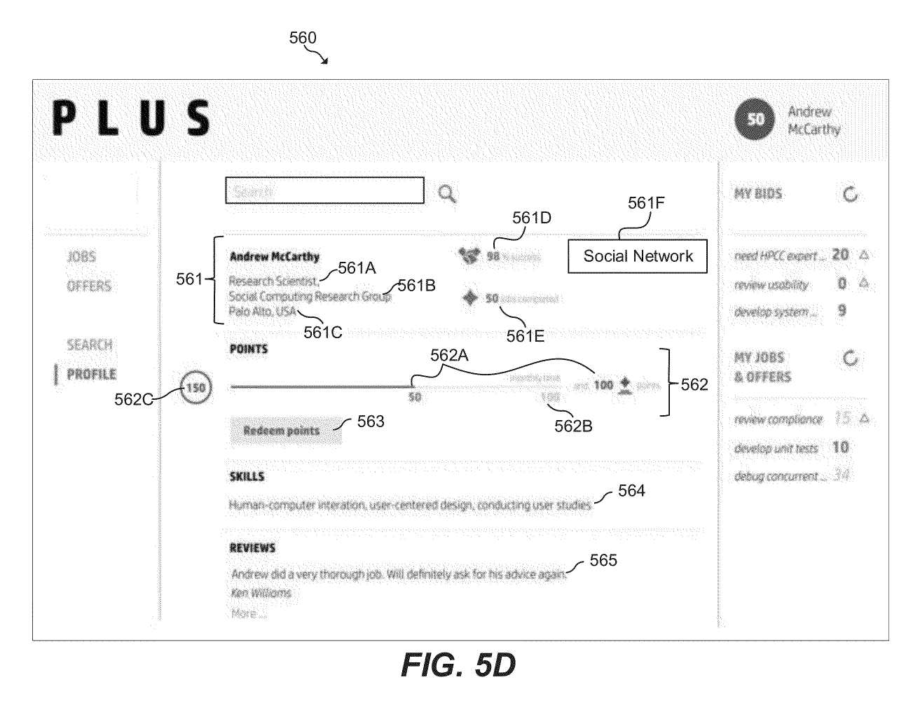

User interfacing instructions 222 may be responsible for controlling interactions between computing device 200 and users. User interfacing instructions 222 may provide a user interface to an application accessed by a user's personal computing device. For example, a user may access the provided user interface with a web browser or cloud-based application on the user's personal computer or mobile device. In an example implementation, the user interface provided may include user controls for viewing user profiles, creating tasks, creating bids, selecting bids, and various other functions. FIGS. 5A-5D, described in detail below, each illustrates an example user interface provided by user interfacing instructions 222.

User managing instructions 223 may manage a number of interactions between users and computing device 200. For example, user managing instructions 223 may control task creation in relation to each user's user profile. In an example implementation, user managing instructions 223 may first retrieve the user profile of a first user from database 230 using database accessing instructions 221. User managing instructions 223 may first check the user profile and applicable limits to verify that the first user can create a task. The first user may then create a task using the user interface provided by user interfacing instructions 222. Upon receiving the task from user interfacing instructions 222, user managing instructions 223 may provide the task to database accessing instructions 221 for storage in database 230.

User managing instructions 223 may also control bid creation by a second user in relation to the second user's user profile and the features of a particular task created by another user. In an example implementation, upon a second user's selection of a task using the user interface provided by user interfacing instructions 222, user managing instructions 223 may receive information for the task from database 230 through database accessing instructions 221. User managing instructions 223 may then retrieve the user profile of the second user and verify that the second user can create a bid for the selected task.

In some implementations, when a second user attempts to create a bid using the user interface provided by user interfacing instructions 222, user managing instructions 223 may verify that the credit amount specified in the bid is not restricted by the credit limit for the task set by the first user, as described above. In other words, when the task is a request, instructions 223 may confirm that the credit amount in the bid does not exceed the maximum credit limit. Alternatively, when the task is an offer, instructions 223 may confirm that the credit amount in the bid is not less than the minimum credit limit. Upon successful verification, user managing instructions 223 may then provide the bid to database accessing instructions 221 for storage in database 230. In some examples where the first user had set other restrictions, user managing instructions 223 may verify that the bid is not limited by such restrictions.

User managing instructions 223 may also control bid selection by the first user. User managing instructions 223 may receive a number of bids created for a particular task from database 230. User managing instructions 223 may then display the bids to the first user by way of a user interface provided by user interfacing instructions 222. User managing instructions 223 may then receive the first user's selection of a bid from user interfacing instructions 222.

Credit managing instructions 224 may manage a credit system for a task marketplace within an organization. For example, credit managing instructions 224 may operate in conjunction with database accessing instructions 221 to manage each user's budget of credits for use in the creation and exchange of tasks and bids. In the implementation depicted in FIG. 2, credit managing instructions 224 may include crediting limiting instructions 224A, credit exchanging instructions 224B, and credit redeeming instructions 224C.

Credit limiting instructions 224A may operate in conjunction with other instructions encoded in machine-readable storage medium 220 to manage a number of interactions relating to credit limits. For example, credit limiting instructions 224A may cooperate with user managing instructions 223 to manage credits during task creation and bid creation.

As one example, credit limiting instructions 224A may limit the number of credits that can be exchanged for performance of a task by a predetermined maximum credit amount. As described above in relation to task 132 of FIG. 1, credit limiting instructions 224A may enforce the highest number of credits a user may assign to any task as determined by another user. The user determining the maximum credit amount may be, for example, a supervisor in an enterprise.

In addition or as an alternative, credit limiting instructions 224A may limit the number of credits that each particular user may earn over a period of time. Credit limiting instructions 224A may cooperate with organization managing instructions 225 to restrict each user's credits according to each user's role within an organization. Further details of credit limits are described in relation to user profiles 131 of FIG. 1.

Credit managing instructions 224 may also include credit exchanging instructions 224B. As with instructions 125 of FIG. 1, credit exchanging instructions 224B may exchange the specified number of credits between a first user and a second user upon performance of the task. For example, credit exchanging instructions 224B may receive the user profiles of the users from database accessing instruction 221, including each user's available number of credits. Upon performance of the task, credit exchanging instructions 224B may deduct the specified number of credits for the task from the user profile of one user and add the specified number of credits to the user profile of the other user. Credit exchanging instructions 224B may then provide the updated user profiles to database accessing instructions 221 for storage in database 230.

In addition to credit limiting instructions 224A and credit exchanging 224B, Credit managing instructions 224 may also include credit redeeming instructions 224C. Credit redeeming instructions 224C may manage a system in the organization that facilitates the trading of credits for rewards. A reward may be anything that encourages participation in the task marketplace. A reward may be offered by an organization for a particular accomplishment, such as earning a specific number of credits or performing a certain number of tasks. In some examples, a number of rewards may be offered by an organization in exchange for credits. In these instances, a user may have a variety of options for redeeming his or her credits.

In some implementations, an organization may be a business enterprise that uses an internal credit system to reward employees who effectively use a task marketplace to assist other employees. In this example, the credits may be converted to a number of different kinds of rewards. For example, the credits may be converted to cash bonuses, extra vacation time, charity donations, or various goods. An employee may choose how to convert the credits the employee has earned. Each employee may be endowed with a budget of credits or, in some implementations, the employee may purchase credits using currency.

Organization managing instructions 225 may manage a number of features relating to the organization. For example, organization managing instructions 225 may operate in conjunction with instructions 221-224 of machine-readable storage medium 220 to control the task marketplace according to parameters of the organization. In some implementations, organization managing instructions 225 may manage creating and performing tasks in view of the hierarchical structure of the organization. Organization managing instructions 225 may identify certain characteristics of user profiles and accordingly provide parameters to computing device 200. For example, an organization may set organization managing instructions 225 to limit collaboration between two employees of a company who do not share a common language. In another example, organization managing instructions 225 may specify the permissions for cross-divisional collaboration with users in specific subgroups. As one specific example, managing instructions 225 may permit such cross-divisional collaboration by the technology support group of an organization whose main responsibility is to support other users.

Alternatively or in addition, organization managing instructions 225 may cooperate with user managing instructions 224 to limit the number of credits each user may earn or the number of tasks each user may perform according to parameters of the organization. Organization managing instructions 225 may also control the parameters of the credit redeeming system managed by credit redeeming instructions 224C. Certain users in the organization, such as managers in a business, may determine the types of rewards available for exchange and the credit conversion rate for those rewards. A business manager may make such determination based on the organization's priorities. For example, the manager may set a low credit exchange rate for donations to a charity, but may set a higher exchange rate for cash bonuses.

Furthermore, when multiple types of credits are used by an organization, some types of credits may be redeemed for rewards and other types may not. On the other hand, some types of points may be exchanged for performance of tasks but may not be redeemed for rewards. Such parameters, which may be controlled by organization managing instructions 225, may allow the organization to exercise flexibility in creating incentives for certain priorities.

Database 230 may be an organized collection of data containing information to be accessed by users within an organization. The data included in database 230 may be maintained in one or more hardware storage devices accessible to computing device 200. Database 230 may be maintained locally to computing device 200 or may be remotely located or hosted in the cloud. It should be noted that the database schema described in detail below may be modified to represent the data in a different manner by, for example, combining one or more tables or splitting the data into additional tables.

User profile records 231 may store data for the user profile of each user in the organization. Each entry in user profile records 231 may include a user identifier, which may operate as a key to identify the user profiles. Each user profile in user profile records 231 may also include the user's credit limit, role in the organization, physical location, skills, and a task history, which may include the number of tasks performed by the user, the user's task performance rate, and reviews for the tasks performed by the user.

Task records 232 may store data for each created task. In particular, each entry in task records 232 may include a task identifier, a credit limit, a time of expiration, a task category, and an action to be performed by one user on behalf of another. Bid records 233 may similarly store data for each created bid. In particular, each entry in bid records 233 may include a bid identifier that also includes an identifier of the task for which the bid was created. Additionally, each entry may include a credit amount and additional features, such as the particular user's experience, availability, and any other information the user provides to distinguish bid 133.

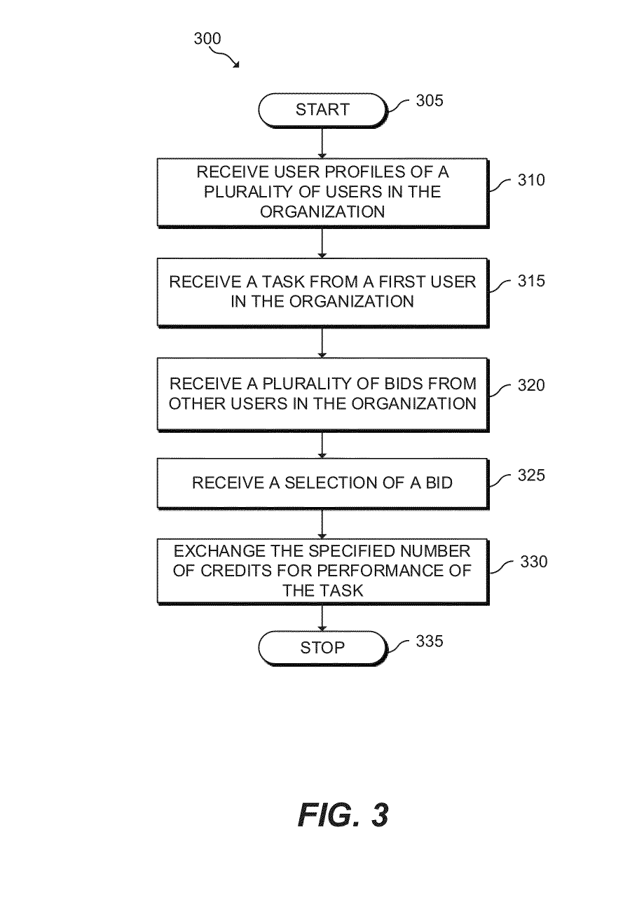

FIG. 3 is a flowchart of an example method 300 for performance of tasks within an organization. Although execution of method 300 is described below with reference to computing device 100 of FIG. 1, other suitable devices for execution of method 300 will be apparent (e.g. computing device 200). Method 300 may be implemented in the form of executable instructions stored on a machine-readable storage medium, such as storage medium 120 of FIG. 1.

Method 300 may start in block 305 and proceed to block 310, where computing device 100 may receive user profiles of a plurality of users in the organization. The user profiles may include any information that assists in creating and performing tasks within an organization and may be accessed from a local database, a cloud-hosted database, a data center, and/or any other information repository. In some implementations, the received user profiles may include a combination of each user's role within the organization, geographical location, skills, number of performed tasks, task performance rate, and reviews for the tasks performed. Examples of user profiles are described in detail above in connection with user profiles 131 of FIG. 1.

Method 300 may then proceed to block 315, where computing device 100 may receive a task from a first user in the organization. The task may be provided by the first user using a user interface on a personal computing device, or the task may be accessed from a database, cloud-hosted database, or data center. In some implementations, the task received in block 315 may include a credit limit, time of expiration, category, and an action to be performed by one user on behalf of another. Examples of tasks are described in detail above in connection with tasks 132 of FIG. 1.

After computing device 100 receives a task, method 300 may proceed to block 320, where computing device 100 may receive a plurality of bids from other users in the organization. Each bid received in block 320 may include a specified number of credits, which may be zero in some cases. In examples where the task created in block 315 includes a credit limit, each bid received in block 320 may be restricted by the credit limit (e.g., computing device 100 may reject each bid with a credit amount restricted by the credit limit). In some implementations, each bid received may also include additional information provided by the second user to help the first user make a selection. Examples of bids are described in detail above in connection with bids 133 of FIG. 1.

Method 300 may then proceed to block 325, where computing device 100 may receive a bid selection from the first user. In some examples, the bid selection may include additional details regarding the task, such as a specific time or method for performance. Method 300 may then proceed to block 330, where computing device 100 may exchange the specified number of credits between the first user and the second user upon performance of the task. After exchanging the specified number of credits, method 300 may proceed to block 335, where method 300 may stop.

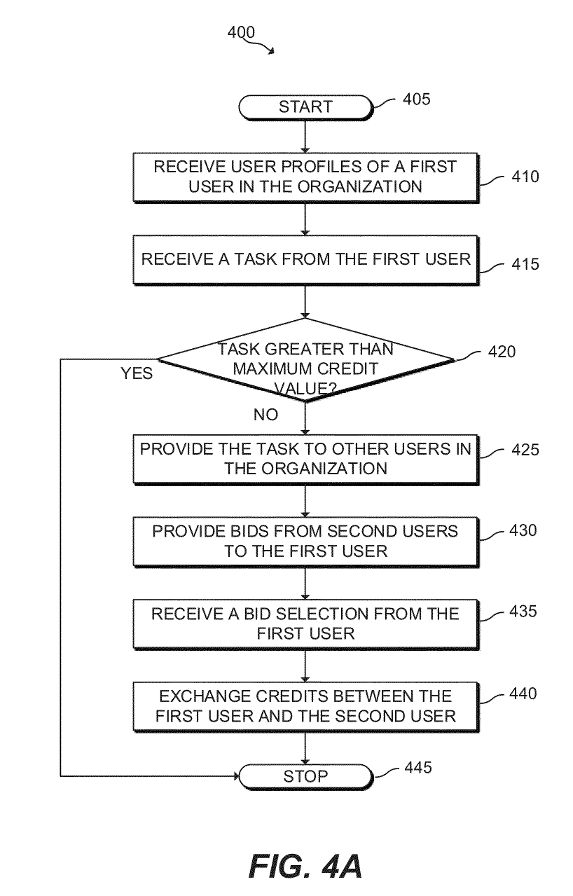

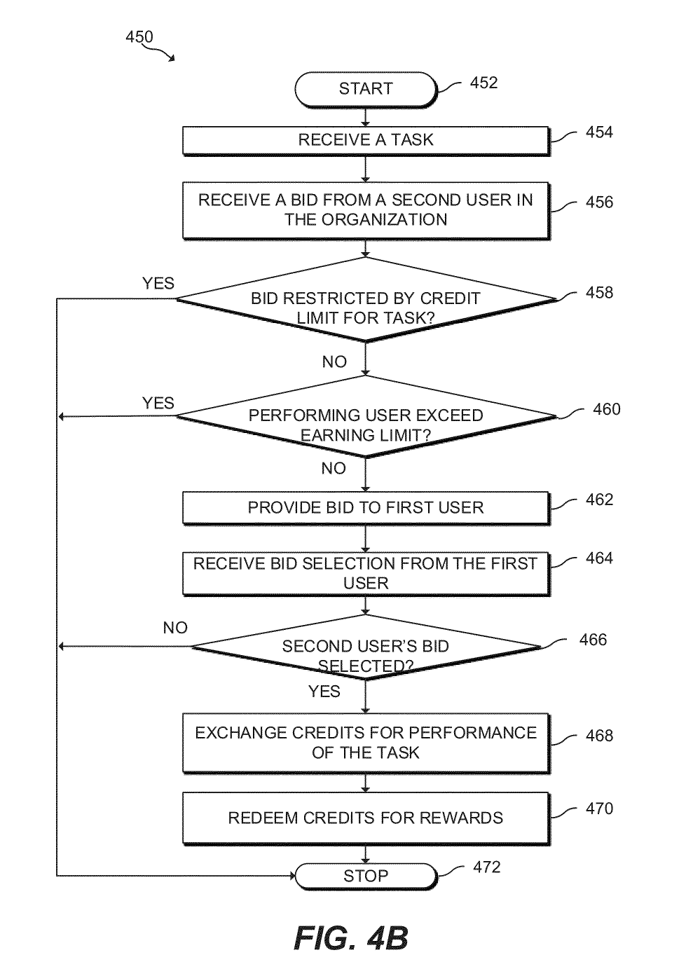

FIG. 4A is a flowchart of an example method 400 for creating a task by a user within an organization. Although execution of method 400 is described below with reference to computing device 200, other suitable components for execution of method 400 will be apparent. Method 400 may be implemented in the form of executable instructions stored on a machine-readable storage medium, such as machine-readable storage medium 220 of FIG. 2.

Method 400 may start in block 405 and proceed to block 410, where computing device 200 may receive the user profile of a first user in the organization. In an example implementation, the user profile may be accessed from database 230 by database accessing instructions 221. The user profile received may include a number of features including, for example, a user identifier, credit limit, role, location, skills, and task history. In some examples, computing device 200 may verify the user can create a task by executing user managing instructions 223, credit managing instructions 224, and organization managing instructions 225.

After computing device 200 receives the user profile, method 400 may proceed to block 415, where computing device 200 may receive a task from the first user. The task may be created by the first user using a user interface provided by user interfacing instructions 222 and then received by computing device 200. The task may include a task identifier, credit limit, expiration, category, and an action to be performed by one user on behalf of another user.

After computing device 200 receives the task from the first user, method 400 may proceed to block 420, where computing device 200 may determine whether the credit limit of the task is no greater than a predetermined maximum credit value. In some examples, the predetermined maximum credit value may be set by another user in the organization and controlled by credit limiting instructions 224A and organization managing instructions 225. If the credit limit of the created task is greater than the predetermined maximum credit value, method 400 may proceed to block 445, where method 400 may stop.

Alternatively, when the credit limit of the created task is less than or equal to the predetermined maximum credit value, method 400 may proceed to block 425, where computing device 200 may provide the task to other users in the organization. In some implementations, database accessing instructions 221 may provide the task to database 230 for storage. Users may then later access the task from database 230 using, for example, a user interface on a personal computing device. Tasks in database 230 may be accessed using various methods. For example, users may search for a list of tasks within a particular category or a list of tasks under a specified credit limit.

After computing device 200 provides the task to other users, method 400 may proceed to block 430, where computing device 200 may provide bids created by second users to the first user. For example, database accessing instructions 221 may retrieve the bids from database 230 and provide these to the first user for selection of a particular bid.

Method 400 may then proceed to block 435, where computing device 200 may receive a bid selection from the first user. The bid selection may indicate the second user chosen to perform the task. In response, computing device 200 may provide the bid selection to the second user that created the particular bid. When the task has been performed, computing device 200 may receive an indication of task completion. Thus, in implementations where the task is a request by the first user for another user to perform a task, the selected second user may perform the task. Alternatively, in examples where the task is an offer by the first user to perform a task for another user, the first user may perform the task on behalf of the selected second user.

Method 400 may then proceed to block 440, where computing device 200 may exchange the number of credits specified in the bid between the first user and the second user upon performance of the task. Method 400 may then stop in block 445.

FIG. 4B is a flowchart of an example method 450 for creating and submitting a bid, by a user within the organization, for the created task of FIG. 4A. Although execution of method 450 is described below with reference to computing device 200, other suitable components for execution of method 450 will be apparent. Method 450 may be implemented in the form of executable instructions stored on a machine-readable storage medium, such as machine-readable storage medium 220 of FIG. 2.

Method 450 may start in block 452 and proceed to block 454, where computing device 200 may receive a task created by a first user in the organization. In some examples, the task may contain a credit limit specified by the first user. Computing device 200 may allow access to the task by other users in the organization by providing the task to database 230 for storage and subsequent retrieval.

Method 450 may then proceed to block 456, where computing device 200 may receive a bid from a second user in the organization for the task received in block 454. The bid may specify a credit amount. Upon receiving the bid, method 450 may proceed to block 458, where computing device 200 may determine whether the credit amount specified in the bid is restricted by the credit limit specified by the first user. In examples where the task is a request, a bid is restricted if the credit amount specified in the bid is greater than the credit limit specified by the first user for the task. In examples where the task is an offer, a bid is restricted if the credit amount in the bid is less than the credit limit for the task. If so, method 450 may proceed to block 472, where method 450 may stop.

Alternatively if the bid is not restricted by the credit limit, method 450 may proceed to block 460, where computing device 200 may determine whether the user to perform the task has exceeded his or her earning limit. As detailed above, the user that will perform the task is the second user when the task is a request and the first user when the task is an offer. In some implementations, the user's earning limit may be a maximum number of credits that the user may earn over a period of time. Alternatively or in addition, the earning limit may be a particular number of tasks each user may perform over a period of time. If the user has exceeded the earning limit, method 450 may proceed to stop in block 472.

Alternatively, when the user who will perform the task has not exceeded his or her earning limit, method 450 may proceed to block 462, where computing device 200 may provide the bid to the first user. The bid may be provided to database 230 for storage, where the first user may later access the bid. After the first user has made a bid selection, method 450 may proceed to block 464, where computing device 200 may receive the bid selection. Method 450 may then proceed to block 466, where computing device 200 may determine whether the bid selection indicates whether the bid created by the second user has been selected by the first user. If the bid created by the second user is not selected, method 450 may proceed to stop in block 472.

If the second user is selected, method 450 may proceed to block 468, where computing device 200 may exchange the specified number of credits for performance of the task. In some examples, when the original task is a request by the first user, computing device 200 may transfer credits from the first user to the second user when the second user completes the task. Alternatively, when the original task is an offer by the first user, computing device 200 may transfer credits from the second user to the first user when the first user completes the task. In some implementations, block 468 may even occur after before the performance of the task. Method 450 may then proceed to block 470, where computing device 200 may allow the redeeming of the user's credits for rewards. Detailed examples of rewards are described above in connection with credit redeeming instructions 225C of FIG. 2.

Method 450 may then proceed to block 472, where method 450 may stop. It should be noted that, in some implementations, method 450 may skip directly to block 472 from block 468. In these implementations, the user forgoes the redeeming of credits for rewards. For example, the user may save the earned credits for later use.

FIG. 5A is a diagram of an example user interface 500 in which a user may create a task. User interface 500 may correspond, for example, to an interface provided by user interfacing instructions 222 of computing device 200 of FIG. 2. In example implementations, user interface 500 may be displayed within a web browser or application on the user's personal computing device. In the example illustrated in FIG. 5A, user interface 500 may include interface areas 501-507.

Interface area 501 may include a user identifier and an indicator of the user's available credits for use. The user identifier may indicate which particular user is accessing user interface 500. In particular, as illustrated, the accessing user is Ken Williams, who has 50 available points, which may be a unit of credits used by the organization. The user identifier and the corresponding number of credits may change with different users accessing user interface 500.

Interface area 502 may include controls for the creation of tasks by users. Interface area 502 may include input fields 502A-502F, where users may input task features. In the example illustrated in FIG. 5A, input field 502A may allow input for a task title, input field 502B may allow input for a task description, input field 502C may allow input for task categories, input field 502D may allow input of a performance deadline, input field 502E may allow input of an expiration time for bid submission, and input field 502F may allow input of a credit limit.

Interface area 503 may include a user input detector, the triggering of which creates a task with the descriptions inputted by the user in interface area 502. The user input detector may be, for example, a button that creates the task upon clicking or activation by touch input.

Interface area 504 may include a search function where the user may search database 230 for stored user profiles, tasks, and bids. Upon entry of a search term and activation of the search button, computing device 200 may query database 230 and display another user interface listing all entries in database 230 containing the search terms inputted by the user.

Interface area 505 may include a switch where the user may choose whether to display the user's own tasks and bids or all tasks and bids within database 230. As illustrated in FIG. 5A, interface area 505 is set to “My,” such that user interface 500 displays the user's own tasks (Ken William's in this example). Setting the switch in interface area 505 to “All” may cause user interface 500 to display all tasks in database 230.

Interface area 506 may include a navigation panel for user interface 500. In the example illustrated in FIG. 5A, interface area 506 includes user selection controls that control a number of interface areas. In particular, a user may select for user interface 500 to display jobs, offers, a search interface, or the user's profile. As illustrated, selecting “Jobs” displays a listing of tasks that are requests in database 230 and displays interface area 502 to allow the creation of new tasks. Selecting “Offers” may display a listing of tasks that are offers and allow creation of new tasks that are offers for service. Selecting “Search” may display a user interface with similar search functions as interface area 504. Selecting “Profile” may display user interface 560, illustrated in FIG. 5D.

Interface area 507 may include a listing of bids created by the user and/or a listing of current tasks created by the offer. In particular, as illustrated, interface area 507 displays bids created by user Ken Williams for a number of tasks (“MY BIDS”) as well as tasks created by user Ken Williams (“MY JOBS & OFFERS”). Additionally, interface area 507 may display the corresponding task for each bid and the number of credits the user specified for each bid. An indicator may be included to inform the user whether each bid or task will result in a gain or a loss of credits. For example, bids displayed in text of a particular font or style may indicate an offer to perform a task, thereby resulting in a gain of credits. Alternatively, a bid displayed in another font or style may indicate a request, thereby resulting in a loss of credits (alternatively, different colors and/or shades of text may be used). Furthermore, as illustrated by the triangles in interface area 507, an indicator may be included to inform the user about whether to pay attention to his or her task or bid. This could be, for example, because the user has been outbid on a task or if a job or offer he or she has created has received no bids.

FIG. 5B is a diagram of an example user interface 520 in which a user may create a bid for a task. User interface 520 may correspond, for example, to an interface provided by user interfacing instructions 222 of computing device 200 of FIG. 2. In example implementations, user interface 520 may be displayed within a web browser or application on the user's personal computing device. In the example illustrated in FIG. 5B, user interface 520 may include interface areas 521-524.

User interface 520 may allow users to create bids for the task identified in interface area 521. As illustrated, interface area 521 may include a task identifier indicating which task is currently displayed. The task identifier may include, for example, the task title, description, and any other information specified by a user when creating a task using interface area 502 of FIG. 5A.

Interface area 522 may include controls for creating a bid for the task identified in interface area 521. Interface area 522 may include input fields 522A and 522B, where users may input bid features. In the example illustrated in FIG. 5B, input field 522A may allow input for a number of credits for which the user is willing to perform the task, while input field 522B may allow input of comments by the user bidding for the task. Interface area 522 may also include indicator 522C which may include an indication of the amount of time remaining before expiration of the timer period for bid submissions. In examples where the task is an offer, input field 522A may instead allow input of a number of credits for which the user is willing to compensate the first user to perform the task.

Interface area 523 may include a user input detector, the triggering of which creates a bid with the descriptions inputted by the user in interface area 522. The user input detector may be, for example, a button that creates the task upon clicking or activation by touch input.

Interface area 524 may include a listing of currently existing bids. The listing may include all created bids, where the bids may be sorted by credit amount. Alternatively, the listing may sort the bids by time of creation. In some examples, the listing may help the user determine what features to include when creating a new bid.

FIG. 5C is a diagram of an example user interface 540 in which a user may select a bid. User interface 540 may correspond, for example, to an interface provided by user interfacing instructions 222 of computing device 200 of FIG. 2. In example implementations, user interface 540 may be displayed within a web browser or application on the user's personal computing device. In the example illustrated in FIG. 5C, user interface 540 may include interface areas 541-543.

Interface area 541 may include an indication of time remaining for bid submission, similar to indicator 522C of user interface 520 illustrated in FIG. 5B. In some implementations, a user may select a bid at any time, even before the time for bid submission has expired. In others, a user may select a bid from a list of created bids once the time of expiration has lapsed. In general, the indication of remaining time tells the user whether time remains for submission of new bids.

Interface area 542 may include controls for the selection of a bid by the user. As illustrated, interface area 542 may include a listing of bids created for the particular task. The listing may be sorted by credit amount or the time of bid creation. The listing may include each bid's description, including the number of credits and written comments. User interface area 542 may also include a user input detector that allows for identification of the particular bid the user has selected. In the example illustrated in FIG. 5C, the user input detector may be a checkbox associated with each bid, the choosing of which indicates selection of the associated bid.

Interface area 543 may also include a user input detector, the selection of which triggers a selection of the bid marked by the user in interface area 542. The user input detector may be, for example, a button that creates the task upon clicking or activation by touch input.

FIG. 5D is a diagram of an example user interface 560 in which a user's profile is displayed. User interface 560 may correspond, for example, to an interface provided by user interfacing instructions 222 of computing device 200 of FIG. 2. In example implementations, user interface 560 may be displayed within a web browser or application on the user's personal computing device. In the example illustrated in FIG. 5D, user interface 560 may include interface areas 561-565.

Interface area 561 may include a number of user profile features for the identified user. In the example illustrated in FIG. 5D, interface area 561 may include user features 561A-561F. User feature 561A may include the user's role within the organization, such as an employee's job title within an enterprise. User feature 561B may include a description of a subgroup or division to which the user belongs. For example, the subgroup may be a particular business unit in a company. User feature 561C may indicate the user's physical location. User feature 561D may include the user's task performance rate, and user 561E may include the total number of tasks performed by the user. User feature 561F may include controls that direct the user to view an external profile of the user. For example, the controls may direct the user to the identified user's profile on an organization-wide social media platform. In the particular implementation illustrated in FIG. 5C, user Andrew McCarthy may be a Research Scientist in the Social Computing Research Group in Palo Alto, USA, who may have performed 50 tasks with a 98% success rate.

Interface area 562 may include a number of credit features for the identified user. In the example in FIG. 5D, interface area 562 may include credit features 562A-562C. Credit feature 526A may indicate the number of credits the user has earned. As described above in relation to FIG. 1, in some examples, two or more types of credits may be used by users to exchange for performance of tasks. In these instances, credit feature 526A may indicate the amount of each type of credit the user has earned. Credit feature 526B may indicate the maximum number of credits the user may earn over a period of time. In some examples, credit feature 526B may indicate the earning limit for each type of credit. Credit feature 562C may include an indicator of other features. For example, credit feature 562C may include the sum of all types of credits earned. In the example illustrated in FIG. 5D, user Andrew McCarthy has earned 50 credits towards the monthly maximum of 100 of a first type of credits and has earned 100 credits of a second type. In this example, user Andrew McCarthy has also earned a sum total of 150 credits of all types. In some examples, all types of credits may be redeemed for rewards, but only certain types of credits may be restricted in the amount that may be earned. Alternatively, some types of credits may be exchanged and redeemed, while other types may be redeemed but not exchanged or vice versa. In the example depicted in FIG. 5D, the first type of credits can both be exchanged for performance of tasks and redeemed for rewards while the second type can only be redeemed.

Interface area 563 may include controls that direct the user to a credit redeeming system. For example, the controls may direct the user to an organization-wide platform where the user may redeem earned credits for particular rewards. Examples and details of credit redeeming systems are described above in relation to credit redeeming instructions 224C of computing device 200 in FIG. 2.

Interface areas 564 and 565 may include additional user profile features. In the example illustrated, interface areas 564 and 565 may include a listing of the user's list of skills and a listing of reviews by other users for tasks performed by the user, respectively.

It should be apparent that various other arrangements and orientations may be used for user interfaces 500, 520, 540, and 560. For example, the interface areas depicted in each of the interfaces may be placed in different locations within the respective user interface 500, 520, 540, 560. Features within interface areas may also be placed in another interface area. Additional interface areas with additional features may also be added to user interfaces 500, 520, 540 and 560, and some interface areas and features may be removed in some implementations.

The foregoing disclosure describes a number of example implementations for creating and performing tasks within organizations. Utilizing the exchange of tasks and bids between members of an organization to facilitate a task market environment, examples disclosed herein enable productive intra-organization collaboration within organizations while limiting the disruption of the primary activities of an organization's members.

What is claimed is:

1. A non-transitory machine-readable storage medium encoded with instructions executable by a processor of a computing device, the machine-readable storage medium comprising instructions to:
receive a user profile of a plurality of users in an organization, the user profile comprising each user's limit of credits for use in compensating other users for performing tasks;
receive a task from a first user in the organization including an action to be performed by one user on behalf of another user;
receive a plurality of bids from other users in the organization, wherein each bid specifies a number of credits to be exchanged between the first user and a second user for performance of the task and wherein the number of credits in each bid is restricted by the limit of credits in the user profile for at least one of the first user and the second user;
receive a selection of a particular bid from the first user; and
exchange the specified number of credits between the first user and the second user for performance of the task.

2. The medium of claim 1, wherein multiple types of credits may be exchanged for performance of tasks, and wherein a specific type of credit may be exchanged only by particular users within the organization.

3. The medium of claim 1, further comprising instructions to redeem the credits for a particular reward, wherein a supervisor of the user in the organization sets the types of rewards available for redeeming and the credit conversion rate for the rewards.

4. The medium of claim 1, further comprising instructions to limit the number of credits a user may exchange for performance of the task based on a predetermined maximum credit amount for the task.

5. The medium of claim 1, wherein:
the task includes a credit limit specified by the first user; and
other users are restricted by the credit limit when providing each bid.

6. The medium of claim 1, wherein the user profile further comprises at least one of: each user's role within the organization, each user's geographical location, skill sets of each user, a number of tasks performed by each user, each user's task performance rate, and reviews for the tasks performed by each user.

7. The medium of claim 1, wherein the task further includes at least one of: a time of expiration and a categorization of the task.

8. The medium of claim 1, further comprising:
instructions to limit performance of tasks by certain users on behalf of certain other users; and
instructions to allow performance of tasks by a user on behalf of another user in a different department within the organization.

9. The medium of claim 1, further comprising instructions to limit the number of credits each user may earn over a period of time, wherein different users have different limits.

10. The medium of claim 1, wherein a supervisor of the user within the organization sets at least one of: a number of credits each user may earn over a period of time and a number of tasks each user may perform over a period of time.

11. A computing device, comprising a processor to:
receive a user profile of a plurality of users in an organization;
receive a task from a first user in the organization including an action to be performed by one user on behalf of another user;
receive a plurality of bids from other users in the organization, wherein each bid specifies a number of credits to be exchanged between the first user and a second user for performance of the task and wherein the number of credits in each bid is restricted by a limit on a number of credits the user performing the task may earn over a period of time;
receive a selection of a particular bid from the first user; and
exchange the specified number of credits between the first user and the second user upon performance of the task.

12. The computing device of claim 11, wherein:
the number of credits provided for performance of the task is limited by a predetermined maximum credit amount for the task.

13. A method, comprising:
receiving, by a computing device, a user profile of a plurality of users in an organization, the user profile comprising each user's limit of credits for use in compensating other users for performing tasks;
receiving a task from a first user in the organization including an action to be performed by one user on behalf of another user and including a credit limit specified by the first user;
receiving a plurality of bids from other users in the organization, wherein each bid specifies a number of credits to be exchanged between the first user and a second user for performance of the task and wherein the number of credits in each bid is restricted by the credit limit specified by the first user in the task;
receiving a selection of a particular bid from the first user; and
exchanging the specified number of credits between the first user and the second user upon performance of the task.

14. The method of claim 13, further comprising limiting the number of credits a user may provide for performance of the task by a predetermined maximum credit amount for the task.

15. The method of claim 13, further comprising at least one of:
limiting the number of credits each user may earn; and
limiting the number of tasks each user may perform.
